(19) United States
(12) Patent Application Publication
(10) Pub. No.: US 2016/0378636 A1
(43) Pub. Date: Dec. 29, 2016

(54) Software-Initiated Trace Integrated with Hardware Trace

(71) Applicant: Intel Corporation, Santa Clara, CA (US)

(72) Inventors: Beeman C. Strong, Portland, OR (US); Jason W. Brandt, Austin, TX (US); Peter Lachner, Heroldstatt (DE); Andreas Kleen, Portland, OR (US); James B. Crossland, Banks, OR (US); Toby Opferman, Hillsboro, OR (US)

(21) Appl. No.: 14/751,759

(22) Filed: Jun. 26, 2015

(51) Int. Cl. G06F 11/34; G06F 11/30

(52) U.S. Cl. CPC G06F 11/3466; G06F 11/3024

(57) ABSTRACT

In an embodiment, a processor includes a core that is to include fetch logic to fetch instructions that include first instructions and a second instruction. The core also includes execution logic to execute the instructions. The execution logic is to retrieve an operand value that is one of an immediate value, a register value, and a memory value stored in a memory location, responsive to execution of the second instruction. The core also includes logic to output a packet that includes a representation of the operand value responsive to execution of the second instruction. The core also includes processor trace (PT) logic to generate a processor trace that includes a plurality of PT packets, where each PT packet correspond to an outcome of execution of a respective first instruction. The processor trace logic is further to include the packet within the processor trace. Other embodiments are described and claimed.

### TECHNICAL FIELD

Embodiments pertain to program trace information.

### BACKGROUND

A processor may support a debug trace capability, which enables generation of packets of data (collectively known as a trace) that describe dynamic software behavior of a program that has executed. The processor may include logic (e.g., dedicated hardware) to output trace information that can indicate outcomes of instructions that have been executed, e.g., taken branches of branch instructions. The trace information can be stored and made available for analysis/debug or to “tune” the program (e.g., streamline the program) for greater execution efficiency.

### BRIEF DESCRIPTION OF THE DRAWINGS

FIG. 1 is a block diagram of a system, according to an embodiment of the present invention.

FIG. 2 is a block diagram of a processor, according to an embodiment of the present invention.

FIG. 3 is a flow chart of a method, according to an embodiment of the present invention.

FIG. 4 is a block diagram of an example system with which embodiments can be used.

FIG. 5 is a block diagram of a system in accordance with an embodiment of the present invention.

### DETAILED DESCRIPTION

Programs that are executed on a processor, e.g., within a system on a chip (SOC), may be analyzed to debug and/or tune the program, through use of trace information (“processor trace”). Typically the trace information output by the processor trace includes “roadmap” data, e.g., indications of taken branches of branch instructions, and may include non-taken branches of branch instructions, and may also include wall-clock time, CPU cycle time, etc.

Other information, such as data values that result from execution of certain instructions, may be valuable in the analysis. In software debug and analysis, ‘printf’-style instrumentation may be used to emit critical information and state. However, printf may be slow to execute. Printf may also be intrusive, potentially causing software behavior to change sufficiently such that an issue for which the analysis is being conducted becomes hidden. Software-generated trace, such as via use of printf, may need thousands of processor cycles in order to execute completely. Additionally, considerable storage may be needed to store output of the software-generated trace, which may be unacceptable, e.g., for performance-sensitive software, or for memory-sensitive software.

There exist other techniques for software to emit trace information. One such technique performs stores to a software trace block that resides in a system on a chip (SoC). For example, in one technique the software stores trace information to memory-mapped input/output (MMIO) addresses, which are then intercepted by a trace capture block in the SoC and sent to a trace output port, or else appended to a running software trace stream in memory storage. However, this technique also brings complexities in its use.

Embodiments allow software to generate trace messages. For example, PTWRITE is a simple and fast new instruction that retrieves an operand value, e.g., stored in a register, stored in memory, an immediate value, etc., and inserts the value as a user-defined payload, in packetized form (e.g., a PTWRITE packet), into a debug trace stream. This trace stream may optionally include other trace information from hardware, including but not limited to control flow trace, data address trace, and data value trace.

The PTWRITE packet may optionally include an instruction pointer (IP) that corresponds to the PTWRITE instruction. The IP enables identification of an origin of the PTWRITE packet, which can in turn enhance understanding of software context and packet payload. The PTWRITE instruction is a low-overhead alternative to a ‘printf’-style debug to enrich existing hardware trace capabilities with software developer-selected information.

PTWRITE, by virtue of its simplicity (e.g., retrieval of a stored value or an immediate value), can typically be executed a single processor cycle and does not need additional storage to store output. Further, PTWRITE logic can reside entirely within the core and so eliminates any dependence on an external trace capture block. PTWRITE further improves upon the MMIO-based trace by simplification of alignment of software trace with the hardware trace. Enablement of software to directly augment the hardware trace rather than to produce a separate, parallel software trace enables precise interleaving of software events and hardware events, e.g., chronological interleaving, or interleaving according to order of instructions within a program. Without such tight integration, post-processing software may need to rely upon timestamp values within the respective software and hardware traces in order to attempt to maintain alignment. Added timestamp information in the traces increases trace size and reduces information density, and also risks imprecise alignment.

In order to disambiguate between multiple software trace messages, MMIO-based schemes typically support a set of channels to which messages are written. Each channel has a separate MMIO address such that messages of a like type will be written to the same channel. These channels often must be allocated and managed by some software agent, and such an MMIO-based scheme requires a developer to choose the correct channel when sending trace messages.

PTWRITE implements a simpler, more elegant solution to disambiguation than MMIO-based schemes. If the user has a need to distinguish packets between one PTWRITE packet and another PTWRITE packet, the user can opt to have the PTWRITE packet (or an associated packet) include a program counter (e.g., instruction pointer (IP)) of the PTWRITE instruction that generated the packet. When combined with software context information, e.g., standard debug information generated by most compilers and that is typically included in any debug trace mechanism, each distinct PTWRITE instruction can have a unique identifier (e.g., IP, or IP and an indication of software context, or another unique identifier) that simplifies the PTWRITE instruction by avoiding the need to provide an explicit identifier (e.g., the address in MMIO-based schemes) The unique identifier makes the PTWRITE instruction easier for a developer to use and avoids a potential need for software management of channel address allocation.

PTWRITE simplifies use of software instrumentation by allowing all messages to be disabled. When PTWRITE is disabled, the instruction will execute without generation of any output. This option to disable PTWRITE output avoids addition of extra code to make execution of instrumentation writes conditional or removal of the instrumentation writes when not in use.

In some embodiments, in order for a consumer of the trace to utilize the information provided via PTWRITE instructions, the consumer may use the PTWRITE instruction identifier to interpret the meaning of the value passed by PTWRITE instruction, which may require additional “sideband” information (e.g., a separate stream of data that may augment the hardware trace) to provide indication of a variable for which the value is associated.

The PTWRITE instruction provides a fast, flexible way for software to augment hardware trace capability with additional information. The PTWRITE instruction may pass an operand (e.g., from a register, a memory value, or immediate value) and the processor may “packetize” the operand value, e.g., by addition of a PTWRITE packet header, to form a packet and insert the packet into the hardware trace stream.

Exemplary usages may include 1) to include, in a control flow trace, function parameter values or return values; 2) to monitor a value of one or more data location(s), to debug, e.g. in memory corruption or sharing issues; and 3) to provide an indication of execution progress through a block of code. Because of its simplicity, PTWRITE (e.g., execution of a PTWRITE instruction and production of PTWRITE packet) can execute very quickly. In a pipelined, out-of-order micro-architecture, an instruction that simply reads a register value or immediate value (e.g., PTWRITE instruction) can take less than one cycle to execute, while a memory operand variety of trace instruction (e.g., MMIO type) typically requires several cycles in order to load a corresponding memory value. PTWRITE delivers the packetized operand value to a hardware trace block, where trace data is collected and delivered to an appointed trace endpoint. If PTWRITE is enabled (e.g., in a model-specific register), the packet is inserted into the trace stream. If PTWRITE is not enabled, no packet is inserted into the trace stream. Additional filtering can optionally be added to suppress PTWRITE packets based on software-selected attributes such as software context, the IP of the PTWRITE, or a security or privilege level from which the PTWRITE is executed, or by other means.

What follows is an example of one way that PTWRITE could be used. Consider a count function below.

int update_count(int delta) {
count = count + delta;
return count;
}

The count function may be called by many other functions to log a count of an event. A user (e.g., programmer) may find that the final count value is incorrect, and the user may want to determine a reason behind the incorrect calculation. A simple control flow trace could be employed, but it would only show the function calls and would not show the variable values. An example trace decoder output for the decoded control flow trace is shown below.

main( ) at main.cc:31

some_func1( ) at main.cc:123

...

some_func7( ) at foo.cc:321

update_count( ) at counter.cc:33 ...

some_func12( ) at bar.cc:22

update_count( ) at counter.cc:33...

some_func99( ) at baz.cc:201

update_count( ) at counter.cc:33 ...

The function can be instrumented with PTWRITE primitives below.

int update_count(int delta) {

_{———}ptwrite(delta);

count = count + delta;

_{——}ptwrite(count);

return count;

}

The compiler can convert these primitives into PTWRITE instructions. Below is an example of what the resulting assembly might look like. (Numbers on the left are IPs that correspond to each instruction.)

FUNC_UPDATE_COUNT:

| | |
|---|---|
| 0x1000 | pop %ebx ;; delta |
| 0x1002 | ptwrite %ebx |
| 0x1008 | mov %eax, [CountAddr] ;; count |
| 0x1010 | add %eax, %ebx |
| 0x1012 | mov [CountAddr], %eax |
| 0x1014 | ptwrite %eax |
| 0x1016 | ret |

Tracing this instrumented version of the code would produce a packet output akin to that shown below. Here the PTWRITE output is interleaved (e.g., interleaved according to program order) with the PT control packets, ensuring proper association of PTWRITE to flow trace output (e.g., taken branch values with each function call) below. Association of the PTWRITE to flow trace output would be very difficult to accomplish accurately using timestamps, especially for functions that are frequently used, because temporal intervals between function calls and software instrumentation messages may be shorter than can be reflected by timestamp granularity.

main( ) at main.cc:31

some_func1( ) at main.cc:123

...

some_func7( ) at foo.cc:321

update_count( ) at counter.cc:33
delta=0x3
count=0x3

...

some_func12( ) at bar.cc:22

update_count( ) at counter.cc:33
delta=0x4
count=0x7

...

some_func99( ) at baz.cc:201

update_count( ) at counter.cc:33
delta=0xfff3
count=0xfffa

...

Through use of the values provided by execution of the PTWRITE instructions, the user can determine which call has caused the value to be corrupted and can pinpoint a source of the corruption.

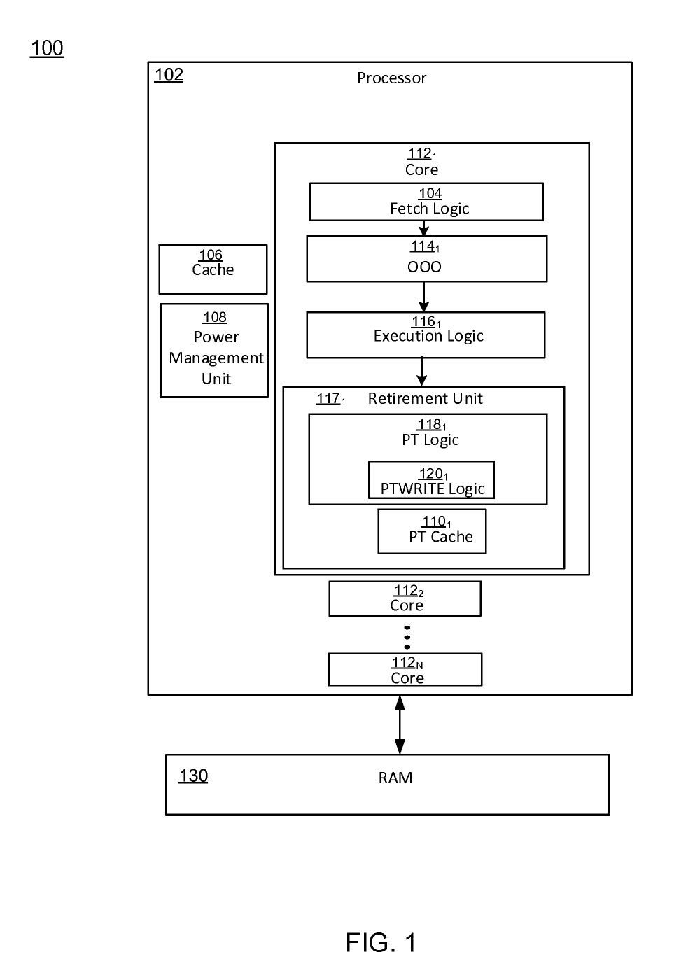

FIG. 1 is a block diagram of a system, according to an embodiment of the present invention. System 100 includes a processor 110 and random access memory (RAM) 130. The processor 110 includes cache memory 106, power management unit 108, one or more cores 112ᵢ, (e.g., 112₁, 112₂, . . . 112_{N}), and may include additional logics (not shown). Core 112₁ includes fetch logic 104, out of order logic (OOO) 114₁, execution logic 116₁, and a retirement unit 117₁ that includes PT logic 118₁ that includes PTWRITE logic 120₁. The retirement unit 117₁ also includes processor trace (PT) cache memory 120₁.

In operation, a program may be compiled, and executable code resulting from the compilation may be stored in RAM 130, to be retrieved by the fetch logic 104 and input to the OOO 114₁ of the core 112₁. Each instruction of the executable code may be input by the OOO 114₁ to the execution logic 118₁ of the core 112₁.

The program may include zero, one, or more PTWRITE instructions, (e.g., added to an original program by a user, such as a programmer). Each PTWRITE instruction, upon execution, is to obtain an operand value of an operand specified by the PTWRITE instruction e.g., a particular data value that may be stored in a specified register, a specified memory location, or an immediate value. The operand value may be useful for debug purposes. Execution of the PTWRITE instructions is to have little to no impact on execution of other portions of the program (e.g., little or no impact on execution of the original program). That is, the PTWRITE instruction does not introduce significant latency into execution of the original program, since it simply retrieves the operand value of a specified operand.

Each data value retrieved by execution of a corresponding PTWRITE instruction may be used, along with other processor trace information, in analysis of the program, e.g., to debug the program and/or to improve execution efficiency, energy efficiency, etc. (e.g., to “tune” the program).

Within the PT logic 120₁, PTWRITE logic 116₁ is to detect execution of each PTWRITE instruction. For each PTWRITE instruction executed by the execution logic 118₁, when PTWRITE is enabled the PTWRITE logic 116₁ is to formulate a corresponding PTWRITE packet, e.g., adding a PTWRITE packet header to the operand value retrieved by the PTWRITE packet. The PTWRITE packet header may be used to identify the PTWRITE packet, e.g., distinguish from all other PT packets.

Upon execution of a (non-PTWRITE) instruction by the execution logic 116₁, the PT logic 120₁ may generate a processor trace packet. Each PT packet is to provide information regarding the outcome of the instruction, e.g., branch taken for a branch instruction, or other diagnostic data. For example, the PT packets to be generated by the PT logic 114₁ may include control flow trace, data address trace, data value trace, and may also include other trace packets.

The PT logic 120₁ may store each PTWRITE packet output by the PTWRITE logic 116₁, along with PT packets that are generated by the PT logic 114₁. The PT logic 120₁ may include the PTWRITE packets in a processor trace, correlated with PT packets so that additional time-stamp correlation is unnecessary. In some embodiments, a PTWRITE packet is to include an instruction pointer (IP) of the corresponding PTWRITE instruction, and the IP can be useful to effect time correlation of the PTWRITE packet with PT packets.

The PT logic 120₁ is to output the processor trace (PT) that includes packets generated by the PT logic 118₁, including PTWRITE packets generated by the PTWRITE logic 120₁. The PT may be stored, e.g., in the PT cache 110, or the PT may be stored in RAM 130 for long term storage that can be of use to the user during debug efforts.

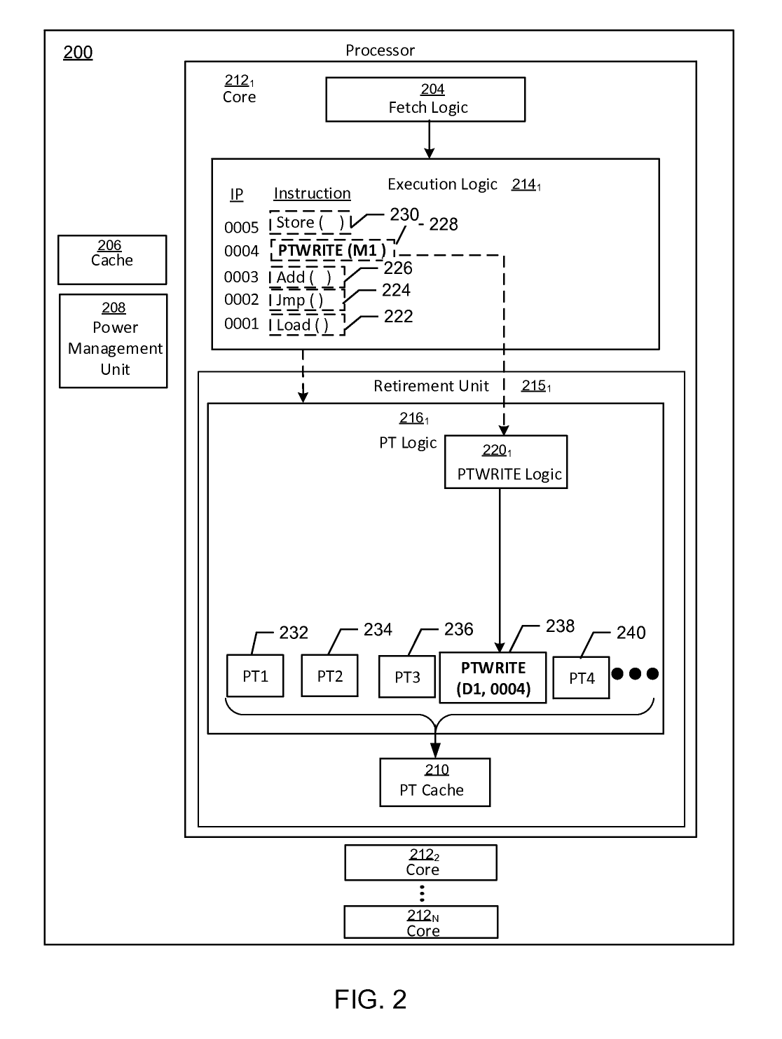

FIG. 2 is a block diagram of a processor, according to an embodiment of the present invention. Processor 200 includes cache memory 206, power management unit 208, and one or more cores 212₁-212_{N}. Core 212₁ includes fetch logic 204, execution logic 214₁, and a retirement unit 215₁ that includes and processor trace (PT) logic 216₁ that includes PTWRITE logic 220₁. The retirement unit 215₁ also includes processor trace (PT) cache 210.

In operation, the core 212₁ may receive, e.g., via the fetch logic 204, executable code, e.g., a program that has been compiled to executable code, e.g., instructions to be executed by the core 212₁. A programmer may have included one or more PTWRITE instructions within the program, e.g., in order to retrieve operand values at particular points of execution of the program. The PTWRITE instructions can be executed “transparently,” e.g., execution of an original program (e.g., prior to inclusion of any PTWRITE instructions) is substantially unaffected by execution of the PTWRITE instructions.

The execution logic 214₁ may execute each instruction of the executable code. For example, a portion of the executable code is to include instructions 222, 224, 226, 228, and 230. Each instruction has a corresponding instruction pointer, e.g., address that is identified with the instruction. As shown in FIG. 2, instruction 222 has IP=0001, instruction 224 has IP=0002, instruction 226 has IP=0003, instruction 228 has IP=0004, and instruction 230 has IP=0005.

As each instruction is executed, the PT logic 216₁ may generate none, or one (or more) processor trace packet. The PT logic 216₁ may generate PT packets that may include, e.g., an indication of a taken branch (direct or indirect branch) or of a branch not taken, or other outcome information based upon execution of the corresponding program instruction. In the example shown in FIG. 2, executed instructions 222, 224, 226, and 230 each cause generation of a respective PT packet 232, 234, 236, and 240. Execution of the PTWRITE instruction 228 causes retrieval of a value of operand M1 (e.g., value D1 stored at storage location M1), and triggers PTWRITE logic 120₁ to form a PTWRITE packet 238. The PTWRITE packet 238 is to include the value D1 stored at the storage location M1, and may optionally include the IP of the PTWRITE instruction 228, e.g., IP=0004. The retrieved quantity D1 is to be “packetized,” e.g., the PTWRITE logic 220₁ is to include the retrieved quantity D1 in a packet and to provide a packet header that identifies the packet to be a PTWRITE packet. In some embodiments, the instruction pointer associated with the PTWRITE packet (IP=0004 in the example shown in FIG. 2) is to be included in the PTWRITE packet. An order of the PT packets to be stored may correspond to the order of execution, and can indicate a chronological relationship between the operand value in the PTWRITE packet and the order of execution of non-PTWRITE instructions.

The PT logic 220₁ may insert PTWRITE packets (produced by the PTWRITE logic 220₁) into a processor trace that includes PT packets. The processor trace, e.g., entirety of PT packets and interleaved PTWRITE packets, is to be output to the PT cache 210. Alternatively or subsequent to storage in the PT cache 210, the processor trace may be stored in long term storage (e.g., RAM). The processor trace may be utilized by a programmer to analyze the program, e.g., debug, tune the program to improve execution efficiency, etc.

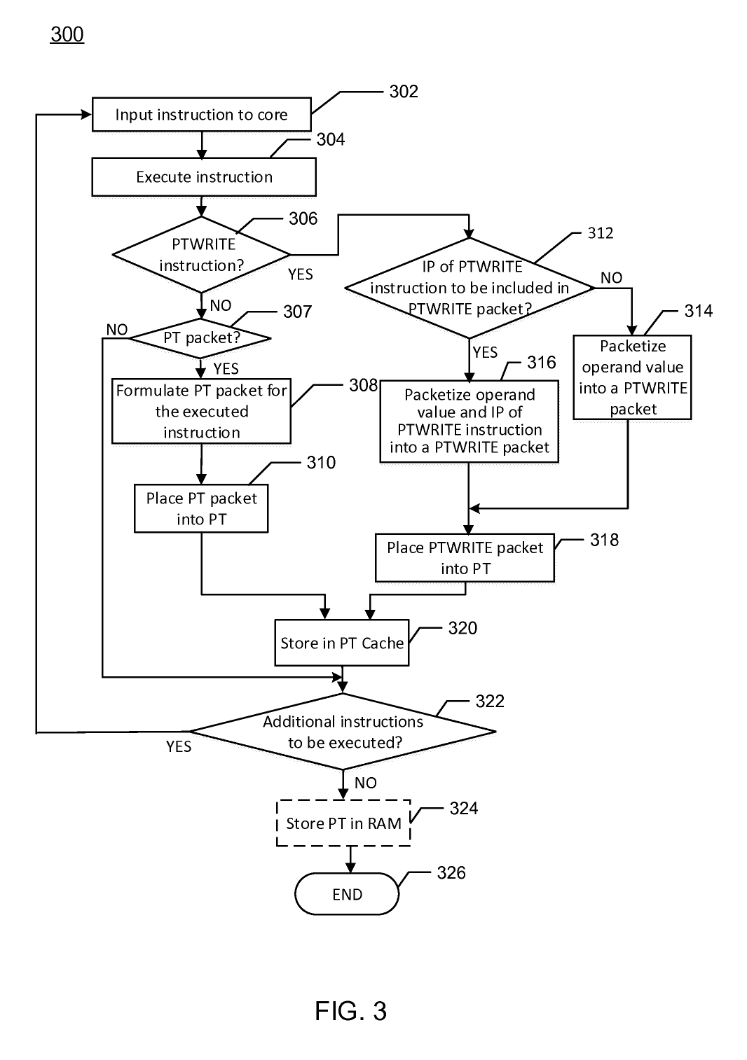

FIG. 3 is a flow diagram of a method, according to an embodiment of the present invention. Method 300 begins at block 302, at which an instruction of a program (e.g., executable code) is input to a core of a processor. Continuing to block 304, the instruction is executed. Advancing to decision diamond 306, if the instruction is not a PTWRITE instruction, continuing to decision diamond 307, if no processor trace packet is to be formulated, the method proceeds to decision diamond 322, and if there are additional instructions to be executed, the method returns to block 302. If a PT packet is to be formulated, advancing to block 308 the PT packet may be formulated based on an outcome of the executed instruction. For example, the executed instruction may be a branch instruction and the PT packet can include an indication of a branch taken as a result of execution of the branch instruction. Proceeding to block 310, if the PT packet is formulated for the executed instruction, the PT packet is placed into a processor trace, e.g., a collection of PT packets. If no PT packet is formulated,

If, at decision diamond 306, the instruction that has been input to the core is a PTWRITE instruction, continuing to decision diamond 312, if an instruction pointer (IP) of the PTWRITE instruction is to be included in a PTWRITE packet the method moves to block 316. At block 316, PTWRITE logic within PT logic of the core is to packetize an operand value (a result of execution of the PTWRITE instruction) and the IP of the PTWRITE instruction into the PTWRITE packet, and the PTWRITE logic is to include a PTWRITE header that differentiates the PTWRITE packet from other PT packets. If, at decision diamond 312, the IP of the PTWRITE instruction is not to be included in the PTWRITE packet, moving to block 314, the PTWRITE logic is to packetize the operand value, including a PTWRITE header that differentiates the PTWRITE packet from other PT packets. Proceeding to block 318, the PTWRITE packet is to be placed (e.g., interleaved) into the processor trace by the PT logic.

Continuing to block 320, the PT logic of the core is to store the PT packet from block 310 or the PTWRITE packet of block 318 into a PT cache of the processor. Advancing to decision diamond 322, if there are additional instructions of the program to be executed, the method returns to block 302. If, at decision diamond 322 there are no additional instructions of the program to be executed, moving to block 324, optionally the processor trace stored in PT cache may be transferred to memory (e.g., RAM) for long term storage. The method ends at 326.

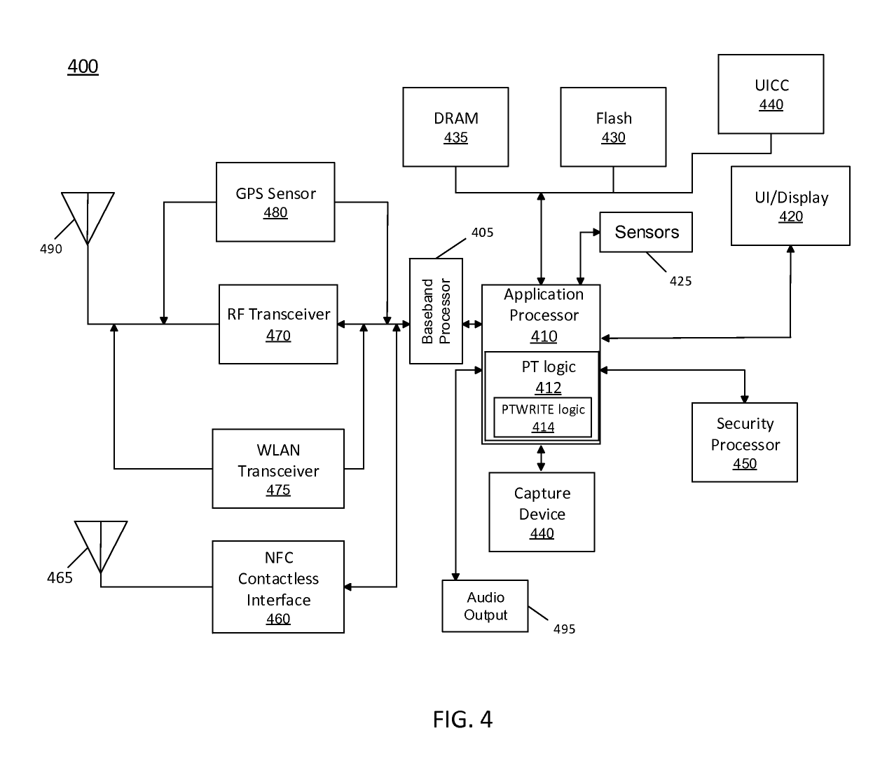

Referring now to FIG. 4, shown is a block diagram of an example system with which embodiments can be used. As seen, system 400 may be a smartphone or other wireless communicator. A baseband processor 405 is configured to perform various signal processing with regard to communication signals to be transmitted from or received by the system. In turn, baseband processor 405 is coupled to an application processor 410, which may be a main CPU of the system to execute an OS and other system software, in addition to user applications such as many well-known social media and multimedia applications. Application processor 410 may further be configured to perform a variety of other computing operations for the device. The application processor 410 may include PT logic 412 to form one or more PT packets for each executed instruction. The PT logic may include PTWRITE logic 414 to packetize (e.g., to form a PTWRITE packet) each parameter value retrieved as a result of execution of a corresponding PTWRITE instruction, according to embodiments of the present invention. Optionally, for one or more of the PTWRITE instructions, the PTWRITE logic 414 may include in the PTWRITE packet an instruction pointer of the PTWRITE instruction, according to embodiments of the present invention. The PT logic 412 may interleave (e.g., chronologically interleave, or interleave according to an order of instructions within a program) the PTWRITE packets into a processor trace that includes a plurality of processor trace packets, each processor trace packet associated with an execution outcome of a corresponding instruction, according to embodiments of the present invention.

In turn, the application processor 410 can couple to a user interface/display 420, e.g., a touch screen display. In addition, application processor 410 may couple to a memory system including a non-volatile memory, namely a flash memory 430 and a system memory, namely a dynamic random access memory (DRAM) 435. As further seen, application processor 410 further couples to a capture device 440 such as one or more image capture devices that can record video and/or still images.

Still referring to FIG. 4, a universal integrated circuit card (UICC) 440 comprising a subscriber identity module and possibly a secure storage and cryptoprocessor is also coupled to application processor 410. System 400 may further include a security processor 450 that may couple to application processor 410. A plurality of sensors 425 may couple to application processor 410 to enable input of a variety of sensed information such as accelerometer and other environmental information. An audio output device 495 may provide an interface to output sound, e.g., in the form of voice communications, played or streaming audio data and so forth.

As further illustrated, a near field communication (NFC) contactless interface 460 is provided that communicates in a NFC near field via an NFC antenna 465. While separate antennae are shown in FIG. 4, understand that in some implementations one antenna or a different set of antennae may be provided to enable various wireless functionality.

To enable communications to be transmitted and received, various circuitry may be coupled between baseband processor 405 and an antenna 490. Specifically, a radio frequency (RF) transceiver 470 and a wireless local area network (WLAN) transceiver 475 may be present. In general, RF transceiver 470 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 480 may be present. Other wireless communications such as receipt or transmission of radio signals, e.g., AM/FM and other signals may also be provided. In addition, via WLAN transceiver 475, local wireless communications can also be realized.

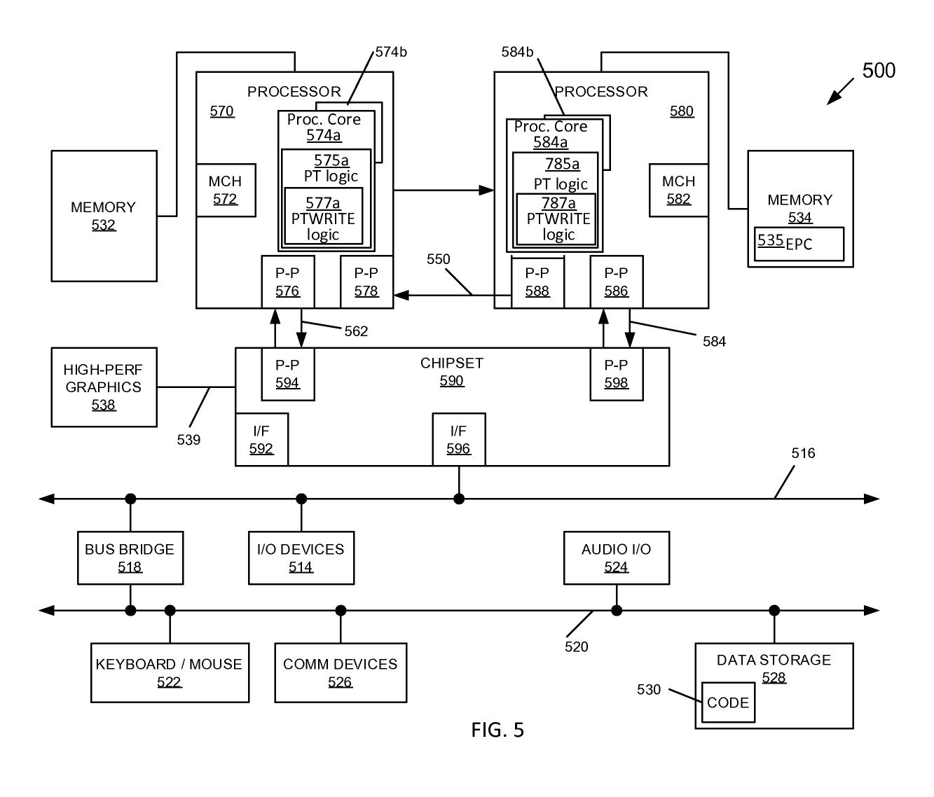

Embodiments may be implemented in many different system types. Referring now to FIG. 5, shown is a block diagram of a system in accordance with an embodiment of the present invention. As shown in FIG. 5, multiprocessor system 500 is a point-to-point interconnect system, and includes a first processor 570 and a second processor 580 coupled via a point-to-point interconnect 550. As shown in FIG. 5, each of processors 570 and 580 may be multicore processors, including first and second processor cores (i.e., processor cores 574a and 574b and processor cores 584a and 584b), although potentially many more cores may be present in the processors. Core 574a includes processor trace (PT) logic 575a that includes PTWRITE logic 577a, and core 584a includes processor trace (PT) logic 585a that includes PTWRITE logic 587a, according to embodiments of the present invention.

In embodiments of the present invention, the PT logic 575a and 585a may create, for each executed instruction of a program, one or more processor trace packets. For each PTWRITE instruction that is executed, the PTWRITE logic 577a and 587a may packetize an operand value of an operand of the PTWRITE instruction (e.g., value stored in a register or storage location, or an immediate value) and may provide a PTWRITE header that is to differentiate the PTWRITE packet from other PT packets. The PT logic 575a and 585a may include (e.g., interleave) each PTWRITE packet into a processor trace that includes a plurality of processor trace packets, where each processor trace packet is associated with an execution outcome of a corresponding instruction, according to embodiments of the present invention. Optionally, for one or more of the PTWRITE instructions, the PTWRITE logic 577a and 587a may include in the PTWRITE packet an instruction pointer of the PTWRITE instruction, according to embodiments of the present invention.

Still referring to FIG. 5, first processor 570 further includes a memory controller hub (MCH) 572 and point-to-point (P-P) interfaces 576 and 578. Similarly, second processor 580 includes a MCH 582 and P-P interfaces 586 and 588. As shown in FIG. 5, MCHs 572 and 582 couple the processors to respective memories, namely a memory 532 and a memory 534, which may be portions of system memory (e.g., DRAM) locally attached to the respective processors. First processor 570 and second processor 580 may be coupled to a chipset 590 via P-P interconnects 562 and 584, respectively. As shown in FIG. 5, chipset 590 includes P-P interfaces 594 and 598.

Furthermore, chipset 590 includes an interface 592 to couple chipset 590 with a high performance graphics engine 538 via a P-P interconnect 539. In turn, chipset 590 may be coupled to a first bus 516 via an interface 596. As shown in FIG. 5, various input/output (I/O) devices 514 may be coupled to first bus 516, along with a bus bridge 518, which couples first bus 516 to a second bus 520. Various devices may be coupled to second bus 520 including, for example, a keyboard/mouse 522, communication devices 526 and a data storage unit 528 such as a disk drive or other mass storage device which may include code 530, in one embodiment. Further, an audio input/output (I/O) 524 may be coupled to second bus 520. Embodiments can be incorporated into other types of systems including mobile devices such as a smart cellular telephone, tablet computer, netbook, Ultrabook™, or so forth.

Additional embodiments are described below.

In a first example, a processor includes a core that is to include fetch logic to fetch instructions that include first instructions and a second instruction. The core is also to include execution logic to execute the instructions, where the execution logic is to retrieve an operand value that is one of an immediate value, a register value, and a memory value stored in a memory location, responsive to execution of the second instruction. The core is also to include logic to output a packet that includes a representation of the operand value responsive to execution of the second instruction. The core is also to include processor trace logic to generate a processor trace (PT) that includes a plurality of PT packets, where each PT packet corresponds to an outcome of execution of a respective first instruction. The processor trace logic is further to include the packet within the processor trace.

A second example includes elements of the first example. Additionally, the packet is to include an indicator that corresponds to an address of the second instruction.

A third example includes elements of the first example. Additionally, the PT logic is to include in the processor trace a first PT packet that includes an indication of a control flow that results from execution of a particular first instruction by the execution logic.

A 4^{th} example includes elements of the first example. Additionally, the PT logic is to include in the processor trace a first PT packet that is to include a data address of output data that results from execution of a particular first instruction by the execution logic.

A 5^{th} example includes elements of the first example. Additionally, the processor is to include a processor trace cache to store the processor trace generated by the processor trace logic.

A 6^{th} example includes elements of the first example. Additionally, the operand value corresponds to an output of execution of a particular first instruction by the execution logic.

A 7^{th} example includes elements of the first example. Additionally, the logic is to include in the packet a header that is to distinguish the packet from the PT packets.

An 8^{th} example includes elements of any one of examples 1 to 7, where the logic is to output a plurality of packets, each packet to correspond to execution of a respective second instruction, and the processor trace logic is to interleave each of the plurality of packets into the processor trace.

A 9^{th} example is a system that includes memory means for storing a program that includes at least one instruction of a first type and at least one instruction of a second type. The system also includes a processor that includes a first core. The first core is to include execution logic to execute the program and to retrieve a first operand value of a first operand responsive to execution of a first instruction of the second type, where the first instruction of the second type specifies the first operand. The core is also to include logic to output a first packet that includes a representation of the first operand value responsive to execution of the first instruction of the second type. The core is also to include processor trace logic to generate, for each instruction of the first type executed, a respective processor trace (PT) packet that corresponds to an outcome of execution of the instruction of the first type, the processor trace logic further to include the first packet in a processor trace that includes each generated PT packet.

A 10^{th} example includes elements of the 9^{th} example. Additionally, the first operand is to include an identifier of a storage location.

An 11^{th} example includes elements of the 9^{th} example. Additionally, the first operand value is to be determined based on execution of a particular instruction of the first type.

A 12^{th} example includes elements of the 9^{th} example. Additionally, the operand specifies an immediate value that is associated with execution of a particular instruction of the first type.

A 13^{th} example includes elements of the 9^{th} example. Additionally, the logic is to include in the first packet an indicator corresponds to an instruction pointer of the first instruction of the second type.

A 14^{th} example includes elements of any one of examples 9 to 13, where the program is to include a plurality of instructions of the second type, where each instruction of the second type has a corresponding identifier, where for each instruction of the second type the logic is to output a corresponding packet that is to include the identifier of the corresponding instruction of the second type.

A 15^{th} example includes elements of example 14, where the identifier corresponds to an instruction pointer of the corresponding instruction of the second type.

A 16^{th} example includes elements of the 14^{th} example, where the processor trace logic is to interleave the packets with the PT packets within the processor trace.

A 17^{th} example is a machine-readable medium having stored thereon data, which if used by at least one machine, cause the at least one machine to fabricate at least one integrated circuit to perform a method that includes executing, by a core, instructions that include at least one instruction of a first type and a an instruction of a second type, where execution of the instruction of the second type results in output of an operand value that is one of an immediate value, a register value and a memory value stored in a memory location; forming, by logic of the core, a packet that includes the operand value; and including the packet into a processor trace (PT) that is to include at least one PT packet, where each PT packet corresponds to an outcome of execution of a corresponding instruction of the first type.

An 18^{th} example includes elements of the 17^{th} example, where the packet is to include a packet header that differentiates the packet from PT packets.

A 19^{th} example includes elements of the 17^{th} example, where the instruction of the second type has an identifier, and where the packet is to include the identifier.

A 20^{th} example includes elements of any one of examples 17 to 19, where the instructions include a plurality of instructions of the second type, where execution of each instruction of the second type is to result in retrieval of a corresponding operand value, and where the method further includes for each instruction of the second type executed forming a corresponding packet that includes the corresponding operand value, and interleaving the corresponding packet with a plurality of PT packets into the processor trace.

A 21^{st} example is a method that includes executing, by a core, instructions that include at least one instruction of a first type and a an instruction of a second type, where execution of the instruction of the second type results in output of an operand value that is one of an immediate value, a register value and a memory value stored in a memory location; forming, by logic of the core, a packet that includes the operand value; and including the packet into a processor trace (PT) that is to include at least one processor trace packet, where each PT packet corresponds to an outcome of execution of a corresponding instruction of the first type.

A 22^{nd} example includes elements of the 21^{st} example, where the packet is to include a packet header that differentiates the packet from PT packets.

A 23^{rd} example includes elements of the 21^{st} example, where the instruction of the second type has an identifier, and where the packet is to include the identifier.

A 24^{th} example includes elements of the 21^{st} example, where the operand value corresponds to an output of execution of a particular instruction of the first type.

A 25^{th} example includes elements of the 21^{st} example, where the instructions include a plurality of instructions of the second type, where execution of each instruction of the second type is to result in retrieval of a corresponding operand value, and the method further includes for each instruction of the second type executed forming a corresponding packet that includes the corresponding operand value, and including the corresponding packet with a plurality of PT packets into the processor trace.

A 26^{th} example includes elements of the 25^{th} example, where including each corresponding packet within the plurality of PT packets into the processor trace includes interleaving each corresponding packet within the plurality of PT packets into the processor trace.

A 27^{th} example includes elements of the 25^{th} example, where each instruction of the second type has a corresponding identifier, and where each corresponding packet is to include the corresponding identifier.

A 28^{th} example includes elements of the 27^{th} example, where each identifier is to include a corresponding indicator that corresponds to an address of the corresponding instruction of the second type.

A 29^{th} example includes elements of the 25^{th} example, where each packet is to include a corresponding packet header that differentiates the packet from PT packets.

A 30^{th} example is an apparatus that includes means for performing the method of any one of examples 21 to 29.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A processor comprising:
a core to include:
fetch logic to fetch instructions that include first instructions and a second instruction;
execution logic to execute the instructions, wherein the execution logic is to retrieve an operand value that is one of an immediate value, a register value, and a memory value stored in a memory location, responsive to execution of the second instruction;
logic to output a packet that includes a representation of the operand value responsive to execution of the second instruction; and
processor trace (PT) logic to generate a processor trace that includes a plurality of PT packets, wherein each PT packet corresponds to an outcome of execution of a respective first instruction, the processor trace logic further to include the packet within the processor trace.

2. The processor of claim 1, wherein the packet is to include an indicator that corresponds to an address of the second instruction.

3. The processor of claim 1, wherein the PT logic is to include in the processor trace a first PT packet that includes an indication of a control flow that results from execution of a particular first instruction by the execution logic.

4. The processor of claim 1, wherein the PT logic is to include in the processor trace a first PT packet that is to include a data address of output data that results from execution of a particular first instruction by the execution logic.

5. The processor of claim 1, further comprising a processor trace cache to store the processor trace generated by the processor trace logic.

6. The processor of claim 1, wherein the operand value corresponds to an output of execution of a particular first instruction by the execution logic.

7. The processor of claim 1, wherein the logic is to include in the packet a header that is to distinguish the packet from the PT packets.

8. The processor of claim 1, wherein the logic is to output a plurality of packets, each packet to correspond to execution of a respective second instruction, and the processor trace logic is to interleave each of the plurality of packets into the processor trace.

9. A system comprising:
a memory to store a program that includes at least one instruction of a first type and at least one instruction of a second type; and
a processor that includes a first core that includes:
execution logic to execute the program and to retrieve a first operand value of a first operand responsive to execution of a first instruction of the second type, wherein the first instruction of the second type specifies the first operand;
logic to output a first packet that includes a representation of the first operand value responsive to execution of the first instruction of the second type; and
processor trace logic to generate, for each instruction of the first type executed, a respective processor trace (PT) packet that corresponds to an outcome of execution of the instruction of the first type, the processor trace logic further to include the first packet in a processor trace that includes each generated PT packet.

10. The system of claim 9, wherein the first operand comprises an identifier of a storage location.

11. The system of claim 9, wherein the first operand value is to be determined based on execution of a particular instruction of the first type.

12. The system of claim 9, wherein the operand specifies an immediate value that is associated with execution of a particular instruction of the first type.

13. The system of claim 9, wherein the logic is to include in the first packet an indicator corresponds to an instruction pointer of the first instruction of the second type.

14. The system of claim 9, wherein the program is to include a plurality of instructions of the second type, wherein each instruction of the second type has a corresponding identifier, wherein for each instruction of the second type the logic is to output a corresponding packet that is to include the identifier of the corresponding instruction of the second type.

15. The system of claim 14, wherein the identifier corresponds to an instruction pointer of the corresponding instruction of the second type.

16. The system of claim 14, wherein the processor trace logic is to interleave the packets with the PT packets within the processor trace.

17. A machine-readable medium having stored thereon data, which if used by at least one machine, cause the at least one machine to fabricate at least one integrated circuit to perform a method comprising:
executing, by a core, instructions that include at least one instruction of a first type and a an instruction of a second type, wherein execution of the instruction of the second type results in output of an operand value that is one of an immediate value, a register value and a memory value stored in a memory location;
forming, by logic of the core, a packet that includes the operand value; and
including the packet into a processor trace (PT) that is to include at least one PT packet, wherein each PT packet corresponds to an outcome of execution of a corresponding instruction of the first type.

18. The machine readable medium of claim 17, wherein the packet is to include a packet header that differentiates the packet from PT packets.

19. The machine-readable medium of claim 17, wherein the instruction of the second type has an identifier, and wherein the packet is to include the identifier.

20. The machine-readable medium of claim 17, wherein the instructions include a plurality of instructions of the second type, wherein execution of each instruction of the second type is to result in retrieval of a corresponding operand value, and wherein the method further includes for each instruction of the second type executed forming a corresponding packet that includes the corresponding operand value, and interleaving the corresponding packet with a plurality of PT packets into the processor trace.
